(19) United States
(12) Patent Application Publication
(10) Pub. No.: US 2025/0368033 A1
(43) Pub. Date: Dec. 4, 2025

(54) FUEL TANK OF ALL-TERRAIN VEHICLE

(71) Applicant: KWANG YANG MOTOR CO., LTD., Kaohsiung City (TW)

(72) Inventor: MING-HSIN YANG, Kaohsiung City (TW)

(21) Appl. No.: 19/194,053

(22) Filed: Apr. 30, 2025

(30) Foreign Application Priority Data
May 31, 2024 (TW) 113205680

(51) Int. Cl. B60K 15/073; B60K 15/03

(52) U.S. Cl. CPC B60K 15/073; B60K 2015/03217; B60K 2015/03243

(57) ABSTRACT

A fuel tank of an all-terrain vehicle is provided. The all-terrain vehicle includes a vehicle frame unit, and a fuel tank that stores fuel for combustion and explosion in a power unit is fastened to the vehicle frame unit. The fuel tank is mounted with a fuel pump and a fuel gauge that separate and independent components, and the fuel pump and the fuel gauge are mounted on the fuel tank separately and in a staggered manner. As such, the fuel storage of the fuel tank can be ensured and the overall stiffness and strength of the fuel tank can be ensured, and mounting engineering of the fuel pump and the fuel gauge is made convenient.

### BACKGROUND OF THE INVENTION

### (a) Technical Field of the Invention

The present invention relates to a fuel tank of an all-terrain vehicle, and more particularly to a fuel tank of an all-terrain vehicle that ensures the fuel storage capacity of the fuel tank and also ensures the overall stiffness and strength of the fuel tank and facilitates the installation of a fuel pump and a fuel gauge.

### (b) Description of the Prior Art

As shown in FIG. 1, an all-terrain vehicle is provided with a fuel tank 1 in front of a seat cushion for storing fuel for combustion and explosion in an engine system. A refueling port 11 is arranged on an upper side of the fuel tank 1 for adding fuel. A fuel pump 13 is arranged in an interior of the fuel tank 1 for drawing fuel in the fuel tank 1 to be supplied and used by the engine system. The installation of the fuel pump 13 is such that the fuel tank 1 is provided with a mounting port 12 toward a vehicle body rear side from where the refueling port 11 is installed and the fuel pump 13 is mounted in the mounting port 12 and extends into the interior of the fuel tank 1. The fuel pump 13 is modularly provided with a fuel gauge 14 that measures fuel storage in the fuel tank 1. The fuel gauge 14 can measure the fuel storage as the fuel in the fuel tank 1 is consumed for being displayed on an instrument that displays vehicle information, in order to reminder a driver to watch the fuel storage in the fuel tank 1, thereby ensuring driving safety.

As shown in FIG. 1, the fuel pump 13 and the fuel gauge 14 are a modularized component, so that the overall width of the fuel pump 13 and the fuel gauge 14 has a certain width. When the fuel pump 13 and the fuel gauge 14 that are modularized together is inserted through the mounting port 12 into the interior of the fuel tank 1, the mounting port 12 must have a relatively large opening size in order to facilitate the installation of the fuel pump 13 and the fuel gauge 14 that are modularized together. Therefore, the top portion of the upper end of the fuel tank 1 includes the refueling port 11 and the mounting port 12 that has a substantial opening size, and thus, the overall stiffness of the top portion of the upper end of the fuel tank 1 is weakened.

Thus, it is a challenge for the all-terrain vehicle manufacturers to provide a fuel tank of an all-terrain vehicle to solve the drawback that a fuel tank upper end portion of the fuel tank of the all-terrain vehicle is weakened due to the installation of a fuel pump and a fuel gauge.

### SUMMARY OF THE INVENTION

The primary objective of the present invention is to provide a fuel tank of an all-terrain vehicle, which is mainly intended to overcome the drawback that the fuel pump and the fuel gauge of the prior art fuel tank of an all-terrain vehicle are difficult to install, and the overall stiffness of the fuel tank is weakened due to the installation of the fuel pump and the fuel gauge.

For such an objective, the present invention provides a fuel tank of an all-terrain vehicle, wherein the all-terrain vehicle comprises a vehicle frame unit, and a fuel tank that stores fuel for combustion and explosion in a power unit is fastened to the vehicle frame unit; the fuel tank is mounted with a fuel pump and a fuel gauge that separate and independent components, and the fuel pump and the fuel gauge are mounted on the fuel tank separately and in a staggered manner.

For such an objective, the present invention provides, in some embodiments, a fuel tank of an all-terrain vehicle, wherein the fuel tank comprises an upper top side and a bottom end side; the fuel pump is mounted on the upper top side of the fuel tank; the fuel gauge is mounted on the bottom end side of the fuel tank.

For such an objective, the present invention provides, in some embodiments, a fuel tank of an all-terrain vehicle, wherein the upper top side is provided, in sequence from a vehicle-body front side to a vehicle-body rear side, with a protruded portion and a slanted portion extending from the protruded portion; the protruded portion is formed with a refueling port penetrating into the fuel tank; the slanted portion is formed with a mounting port penetrating into the fuel tank, the fuel pump is mounted on the mounting port.

For such an objective, the present invention provides, in some embodiments, a fuel tank of an all-terrain vehicle, wherein the bottom end side at least comprises one step portion, and the step portion is formed with a mounting hole, the fuel gauge being mounted on the mounting hole.

For such an objective, the present invention provides, in some embodiments, a fuel tank of an all-terrain vehicle, the fuel gauge comprises a mounting seat and a metering portion arranged on the mounting seat.

For such an objective, the present invention provides, in some embodiments, a fuel tank of an all-terrain vehicle, wherein the mounting seat comprises a leak-proof gasket.

For such an objective, the present invention provides, in some embodiments, a fuel tank of an all-terrain vehicle, wherein the metering portion comprises a rod extending from the mounting seat and a floating body sleeved on the rod.

For such an objective, the present invention provides, in some embodiments, a fuel tank of an all-terrain vehicle, wherein the rod comprises a sliding rod portion having a reduced diameter, and an end of the sliding rod portion is provided with a stop portion having an expanded diameter; the floating body is sleeved on the sliding rod portion.

For such an objective, the present invention provides, in some embodiments, a fuel tank of an all-terrain vehicle, wherein the fuel pump and the fuel gauge mounted on the fuel tank in an up-and-down staggered manner.

For such an objective, the present invention provides, in some embodiments, a fuel tank of an all-terrain vehicle, wherein the bottom end side comprises a first step portion and a second step portion; the fuel pump comprises a filtering member, and the filtering member is located in the second step portion; the first step portion is formed with a mounting hole, the fuel gauge being mounted on the mounting hole.

The efficacy that the present invention may achieve in some embodiments is that the fuel storage of the fuel tank can be ensured and the overall stiffness and strength of the fuel tank can be ensured, and mounting engineering of the fuel pump and the fuel gauge is made convenient.

The efficacy that the present invention may achieve in some embodiments is that the overall stiffness and strength of the fuel tank can be ensured, and mounting engineering of the fuel pump and the fuel gauge is made convenient.

The efficacy that the present invention may achieve in some embodiments is that the overall stiffness and strength of the upper top side of the fuel tank can be ensured, and mounting engineering of the fuel pump is made convenient.

The efficacy that the present invention may achieve in some embodiments is that the overall stiffness and strength of the upper top side of the fuel tank can be ensured, and mounting engineering of the fuel pump is made convenient.

The efficacy that the present invention may achieve in some embodiments is that the overall stiffness and strength of the bottom portion of the fuel tank can be ensured, and mounting engineering of the fuel gauge is made convenient.

The efficacy that the present invention may achieve in some embodiments is that mounting engineering of the fuel gauge is made convenient.

The efficacy that the present invention may achieve in some embodiments is that an anti-leakage effect of the bottom end portion of the fuel tank is ensured.

The efficacy that the present invention may achieve in some embodiments is that a metering effect of the fuel gauge is improved.

The efficacy that the present invention may achieve in some embodiments is that the fuel storage of the fuel tank can be ensured and the overall stiffness and strength of the fuel tank can be ensured, and mounting engineering of the fuel pump and the fuel gauge is made convenient.

The efficacy that the present invention may achieve in some embodiments is that the combustion effect of the fuel pump sucking the fuel tank is ensured, and mounting engineering of the fuel pump and the fuel gauge is made convenient.

### BRIEF DESCRIPTION OF THE DRAWINGS

FIG. 1 is a schematic view showing a prior art fuel tank of an all-terrain vehicle.

FIG. 2 is a schematic view showing an all-terrain vehicle of the present invention.

FIG. 3 is an exploded view showing a fuel tank of the all-terrain vehicle of the present invention.

FIG. 4 is a side elevational view showing the fuel tank of the all-terrain vehicle of the present invention.

FIGS. 5 and 6 are schematic views illustrating a fuel metering operation of the fuel tank of the all-terrain vehicle of the present invention.

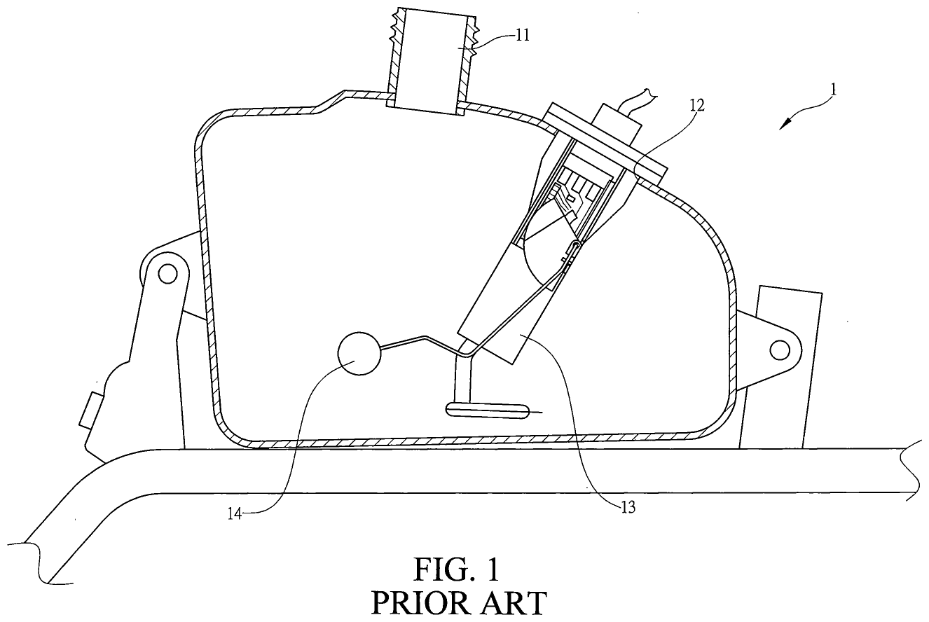

### DETAILED DESCRIPTION OF THE PREFERRED EMBODIMENTS

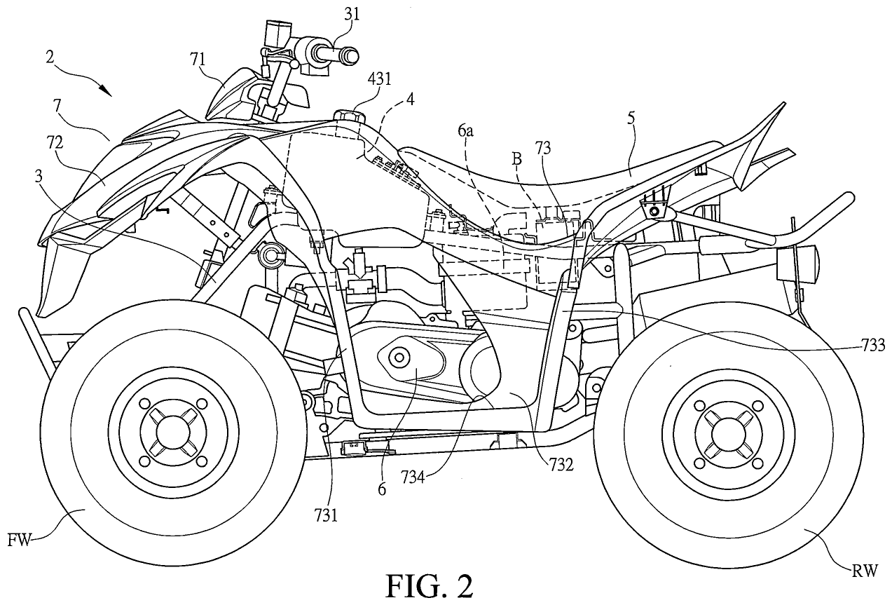

Firstly, referring first to FIG. 2, the present invention provides a fuel tank of an all-terrain vehicle. The all-terrain vehicle 2 comprises a vehicle frame unit 3, front wheels FW, a fuel tank 4, a seat cushion 5, rear wheels RW, a power unit 6, and a vehicle body cover unit 7 that is set on and covers an outside of the vehicle frame unit 3.

As shown in FIG. 2, a steering mechanism 31 is rotatably arranged on a front of the vehicle frame unit 3. A set of front wheels FW are arranged on a lower side of the steering mechanism 31. A fuel tank 4 and a seat cushion 5 are provided on an upper side of the vehicle frame unit 3 and are arranged in sequence toward a vehicle-body rear side, that is the fuel tank 4 is arranged between the steering mechanism 31 and the seat cushion 5. The seat cushion 5 can be lifted upward from the vehicle frame unit 3. A set of rear wheels RW that are driven by the power unit 6 are connected to a rear of the vehicle frame unit 3.

As shown in FIG. 2, the power unit 6 is arranged at a lower side of the seat cushion 5 and is suspended on the vehicle frame unit 3. An air intake and filter unit 6a is connected to an upper side of the power unit 6. When the all-terrain vehicle 2 is in operation, fresh air from the outside is filtered by the air intake and filter unit 6a, and filtered fresh air from the outside is mixed with the fuel from the fuel tank 4 to form a fuel-air mixture, which is combusted and explodes in a cylinder of the power unit 6 to generate power, with which the power unit 6 drives the rear wheels RW to rotate, and the rear wheels RW drive the front wheels FW to synchronously rotate to thereby achieve the purpose of moving. Toward the vehicle-body rear side from the air intake and filter unit 6a and located at a lower side of the seat cushion 5 is an electrical battery B that supplies electrical power for operation of electrical components of the all-terrain vehicle 2.

As shown in FIG. 2, the vehicle body cover unit 7 comprises a vehicle head cover 71 set on and covering a front end of the steering mechanism 31, a front vehicle body cover 72 set on and covering a front end of the all-terrain vehicle 2, and lateral vehicle body covers 73 located on two sides below the seat cushion 5. The lateral vehicle body covers 73 comprise a front fender 731 located at a front lower side of the seat cushion 5, a side body cover 732 located at a lateral lower side of the seat cushion 5, a rear fender 733 located at a rear side of the side body cover 732. A tread board 734 that is extended from the side body cover 732 is arranged between the front fender 731 and the rear fender 733.

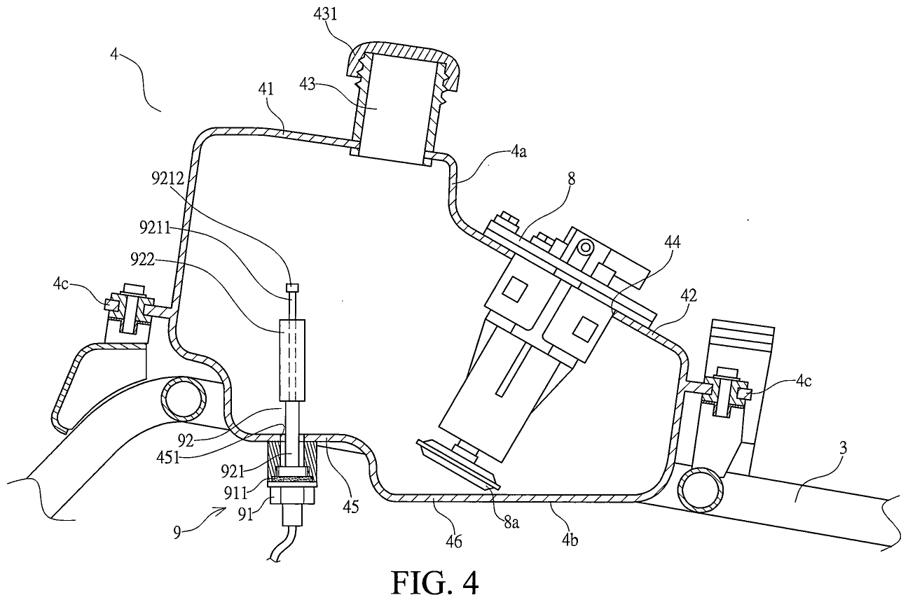

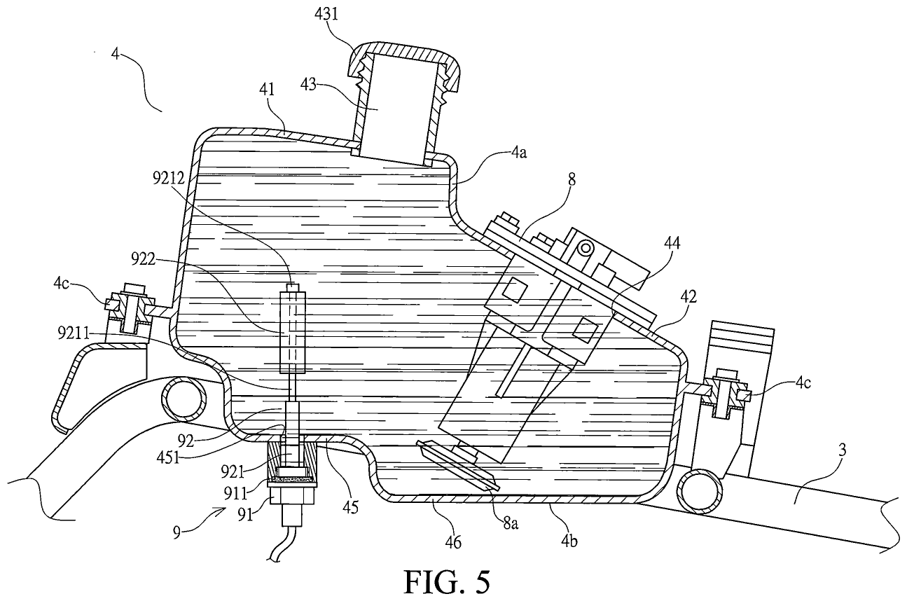

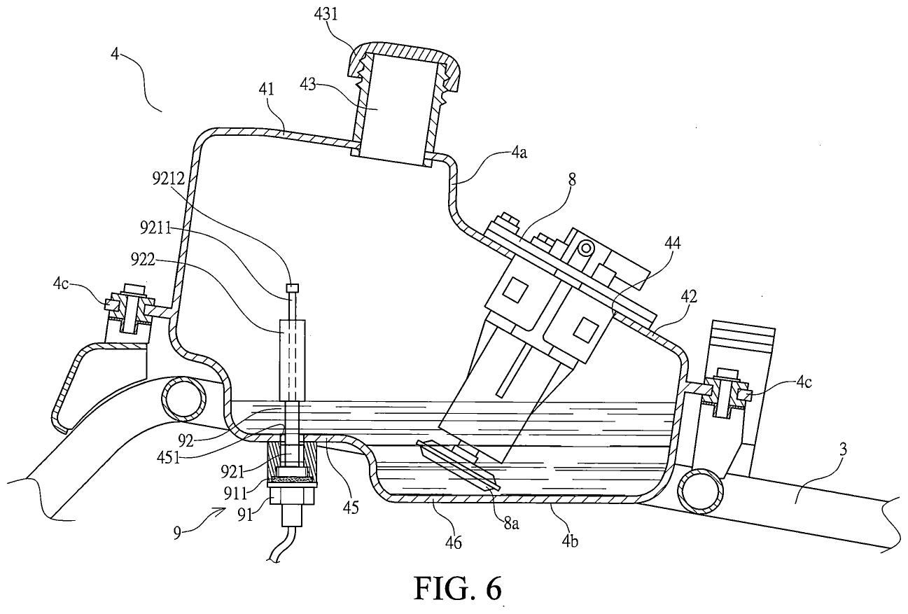

As shown in FIGS. 2, 3, 4, 5, and 6, the fuel tank 4 is a closed box. An upper top side 4a of the fuel tank 4 is protruded upward, toward a vehicle-body upper side, to form a protruded portion 41 located toward the vehicle body front side, and the upper top side 4a is formed, toward the vehicle body rear side, with a slanted portion 42 to form a stepped configuration with respect to the protruded portion 41. The slanted portion 42 inclines toward the vehicle-body rear side from the protruded portion 41, so that the upper top side 4a of the fuel tank 4 is provided with certain stiffness and strength by means of the slanted portion 42 and the protruded portion 41. A refueling port 43 is formed at the site of the protruded portion 41 and communicates with the interior of the fuel tank 4. The refueling port 43 is provided to allow external fuel to be added into the fuel tank 4. A refueling port cover 431 is screwed onto the refueling port 43, and the refueling port cover 431 can close the refueling port 43, so as to prevent external foreign matter from entering the fuel tank 4. A mounting port 44 is formed in the slanted portion 42 and communicates with the interior of the fuel tank 4. The mounting port 44 is provided for mounting a fuel pump 8. Since in the present invention, the fuel pump 8 is not provided with a fuel gauge 9 in a modularized manner, the opening size of the mounting port 44 does not need to be enlarged, so that the stiffness and strength of the slanted portion 42 of the upper top side 4a of the fuel tank 4 will not be damaged and it is possible to maintain certain stiffness and strength. A bottom end side 4b of the fuel tank 4 that is opposite to the upper top side 4a at least comprises one step portion, and the present invention is implemented by setting two step portions to improve the stiffness and strength of the bottom end side 4b of the fuel tank 4. The bottom end side 4b comprises a first step portion 45 located toward the vehicle-body front side and a second step portion 46 located toward the vehicle-body rear side. The second step portion 46 is extended further toward the vehicle-body lower side than the first step portion 45, so as to allow the interior of the fuel tank 4 to have a larger capacity for accommodating fuel. Furthermore, the second step portion 46 is the lowest storage location for storing fuel in the fuel tank 4. The first step portion 45 is formed with a mounting hole 451 penetrating into the interior of the fuel tank 4, and the mounting hole 451 is provided for mounting a fuel gauge 9. A fastening flange 4c is extended from an outer wall circumference of the fuel tank 4, and the fuel tank 4 is fastened to the vehicle frame unit 3 by means of the fastening flange 4c, so as to have the fuel tank 4 securely fastened to and positioned on the vehicle frame unit 3.

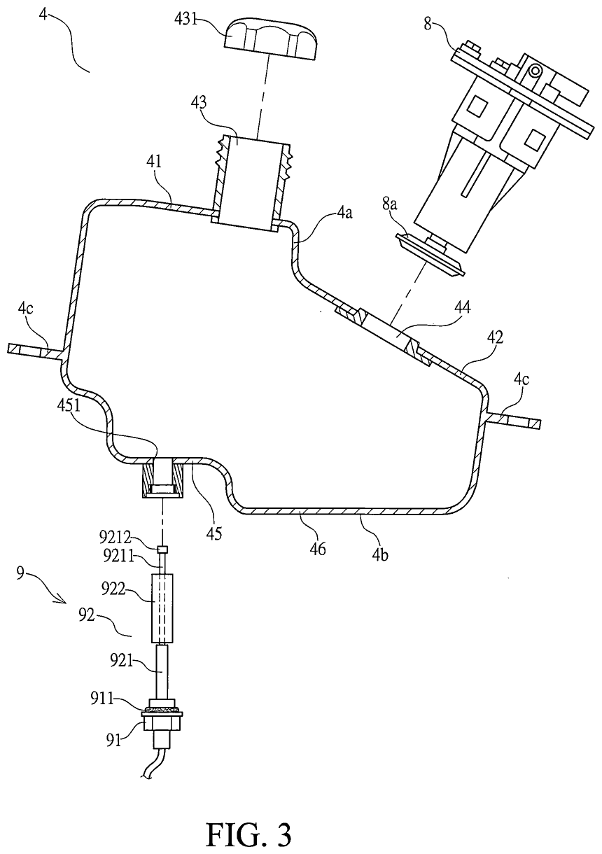

As shown in FIGS. 3, 4, 5, and 6, after the fuel pump 8 is mounted through the mounting port 44, a filtering member 8a of the fuel pump 8 (namely a fuel suction port of the fuel pump 8) that sucks in the fuel in the fuel tank 4 is located at the second step portion 46, so as to ensure that the position where the fuel pump 8 sucks in fuel in at the lowest position of fuel storage in the fuel tank 4 to thereby ensure the effect of the fuel pump 8 sucking in fuel. The fuel gauge 9 is mounted by inserting from the vehicle-body lower side toward the vehicle-body upper side through the mounting hole 451 into the fuel tank 4. The fuel gauge 9 comprises a mounting seat 91 and a metering portion 92 extending upward from the mounting seat 91. The mounting seat 91 is fastened to the mounting hole 451, and the mounting seat 91 comprises a leak-proof gasket 911 to prevent fuel in the fuel tank 4 from leaking out through the mounting seat 91. The metering portion 92 comprises a rod 921 and a floating body 922 slidably mounted on the rod 921. One end of the rod 921 is inserted into the mounting seat 91, and one end of the rod 921 away from the mounting seat 91 is provided with a sliding rod portion 9211 with a reduced diameter. An upper end of the sliding rod portion 9211 is provided with a stop portion 9212 with an expanded diameter, and the floating body 922 is mounted on the sliding rod portion 9211 in a manner of being penetrated thereby. More specifically, the floating body 922 slides up and down between a lower end of the sliding rod portion 9211 and the stop portion 9212 along with the fuel storage amount in the fuel tank 4 so as to measure the fuel amount in the fuel tank 4. The way of measurement performed with the floating body 922 and the sliding rod portion 9211 can be a resistance-based manner or an electromagnetic manner. Further, the fuel gauge 9 is electrically connected to an instrument (not shown) of the all-terrain vehicle 2 that display vehicle information for being displayed thereby. The fuel pump 8 and the fuel gauge 9 are separate and independent components and are respectively mounted on an upper side (the upper top side 4a) and a lower side (the bottom end side 4b) of the fuel tank 4 in a staggered manner, and more specifically, the fuel gauge 9 corresponds, in an upper side, to the protruded portion 41 of the upper top side 4a, while the fuel pump 8 corresponds to the second step portion 46 of the bottom end side 4b, so that the fuel tank 4 of the present invention does not needs to form a large-sized opening for mounting the fuel pump 8 and the fuel gauge 9, and therefore, the overall stiffness and strength of the fuel tank 4 of the present invention can be effectively maintained. It is worth mentioning that convenience of mounting engineering of the fuel pump 8 and the fuel gauge 9 can be further improved.

The present invention is mainly such that an all-terrain vehicle 2 comprises a vehicle frame unit 3, and a fuel tank 4 that stores fuel for combustion and explosion in a power unit 6 is fastened to the vehicle frame unit 3; the fuel tank 4 is mounted with a fuel pump 8 and a fuel gauge 9 that separate and independent components, and the fuel pump 8 and the fuel gauge 9 are mounted on the fuel tank 4 separately and in a 10 staggered manner; as such, the fuel storage of the fuel tank 4 can be ensured and the overall stiffness and strength of the fuel tank 4 can be ensured, and mounting engineering of the fuel pump 8 and the fuel gauge 9 is made convenient.

I claim:

1. A fuel tank of an all-terrain vehicle, wherein the all-terrain vehicle comprises a vehicle frame unit, and a fuel tank that stores fuel for combustion and explosion in a power unit is fastened to the vehicle frame unit; the fuel tank is mounted with a fuel pump and a fuel gauge that separate and independent components, and the fuel pump and the fuel gauge are mounted on the fuel tank separately and in a staggered manner.

2. The fuel tank of the all-terrain vehicle according to claim 1, wherein the fuel tank comprises an upper top side and a bottom end side; the fuel pump is mounted on the upper top side of the fuel tank; the fuel gauge is mounted on the bottom end side of the fuel tank.

3. The fuel tank of the all-terrain vehicle according to claim 2, wherein the upper top side is provided, in sequence from a vehicle-body front side to a vehicle-body rear side, with a protruded portion and a slanted portion extending from the protruded portion; the protruded portion is formed with a refueling port penetrating into the fuel tank; the slanted portion is formed with a mounting port penetrating into the fuel tank, the fuel pump is mounted on the mounting port.

4. The fuel tank of the all-terrain vehicle according to claim 2, wherein the bottom end side at least comprises one step portion, and the step portion is formed with a mounting hole, the fuel gauge being mounted on the mounting hole.

5. The fuel tank of the all-terrain vehicle according to claim 1, wherein the fuel gauge comprises a mounting seat and a metering portion arranged on the mounting seat.

6. The fuel tank of the all-terrain vehicle according to claim 2, wherein the fuel gauge comprises a mounting seat and a metering portion arranged on the mounting seat.

7. The fuel tank of the all-terrain vehicle according to claim 4, wherein the fuel gauge comprises a mounting seat and a metering portion arranged on the mounting seat.

8. The fuel tank of the all-terrain vehicle according to claim 5, wherein the mounting seat comprises a leak-proof gasket.

9. The fuel tank of the all-terrain vehicle according to claim 6, wherein the mounting seat comprises a leak-proof gasket.

10. The fuel tank of the all-terrain vehicle according to claim 7, wherein the mounting seat comprises a leak-proof gasket.

11. The fuel tank of the all-terrain vehicle according to claim 5, wherein the metering portion comprises a rod extending from the mounting seat and a floating body sleeved on the rod.

12. The fuel tank of the all-terrain vehicle according to claim 6, wherein the metering portion comprises a rod extending from the mounting seat and a floating body sleeved on the rod.

13. The fuel tank of the all-terrain vehicle according to claim 7, wherein the metering portion comprises a rod extending from the mounting seat and a floating body sleeved on the rod.

14. The fuel tank of the all-terrain vehicle according to claim 11, wherein the rod comprises a sliding rod portion having a reduced diameter, and an end of the sliding rod portion is provided with a stop portion having an expanded diameter; the floating body is sleeved on the sliding rod portion.

15. The fuel tank of the all-terrain vehicle according to claim 12, wherein the rod comprises a sliding rod portion having a reduced diameter, and an end of the sliding rod portion is provided with a stop portion having an expanded diameter; the floating body is sleeved on the sliding rod portion.

16. The fuel tank of the all-terrain vehicle according to claim 13, wherein the rod comprises a sliding rod portion having a reduced diameter, and an end of the sliding rod portion is provided with a stop portion having an expanded diameter; the floating body is sleeved on the sliding rod portion.

17. The fuel tank of the all-terrain vehicle according to claim 1, wherein the fuel pump and the fuel gauge mounted on the fuel tank in an up-and-down staggered manner.

18. The fuel tank of the all-terrain vehicle according to claim 2, wherein the bottom end side comprises a first step portion and a second step portion; the fuel pump comprises a filtering member, and the filtering member is located in the second step portion; the first step portion is formed with a mounting hole, the fuel gauge being mounted on the mounting hole.
